(19) United States
(12) Patent Application Publication
(10) Pub. No.: US 2001/0005264 A1
(43) Pub. Date: Jun. 28, 2001

(54) Linked cameras and processors for imaging system

(76) Inventors: Charles S. Slemon, Encinitas, CA (US); W. James Frandsen, San Diego, CA (US); Raymond H. Bratton, Santee, CA (US); James John Glover, La Mesa, CA (US)

Correspondence Address: NEIL K. NYDEGGER, NYDEGGER & ASSOCIATES, 348 Olive Street, San Diego, CA, 92103, US

(21) Appl. No.: 09/785,371

(22) Filed: Feb. 16, 2001

Related U.S. Application Data
(63) Continuation-in-part of application No. 09/553,986, filed on Apr. 20, 2000, now Pat. No. 6,191,856.
Application No. 09/553,986 is a continuation-in-part of application No. 09/305,608, filed on May 5, 1999.

(51) Int. Cl. G01N 21/00

(52) U.S. Cl. 356/237.2

(57) ABSTRACT

An inspection system for identifying defects on the surface of an item includes an information processor mounted on a base assembly. A tray is used to move the item to an inspection station on the base assembly, and an illuminator is provided at the inspection station to illuminate the item from different visual perspectives. Importantly, the illuminator includes a plurality of different light sources. An N number of cameras and an M number of image processors are operated in concert to collect image data from the illuminated item. This image data is then analyzed using the image processors to compare the image data with a template image to detect defects in the item. In the operation of the inspection system, the tray, the illuminator, the cameras and the image processors are all centrally controlled and coordinated by an central information processor.

This application is a continuation-in-part of application Ser. No. 09/553,986 filed Apr. 20, 2000, which is currently pending and is a continuation-in-part of application Ser. No. 09/305,608 filed May 5, 1999, which is currently pending. The contents of application Ser. No. 09/553,986 and application Ser. No. 09/305,608 are incorporated herein by reference.

### FIELD OF THE INVENTION

The present invention pertains generally to inspection systems. More particularly, the present invention pertains to inspection systems that rely on optical imaging techniques for evaluation of the item being inspected. The present invention is particularly, but not exclusively, useful as an inspection system that is controlled in its operation by a central information processor.

### BACKGROUND OF THE INVENTION

Like most everything, the visual inspection of an item has some advantages and some disadvantages. On the plus side, a visual inspection can be quick, accurate and effective for many purposes. Also, visual inspections can be accomplished without dismantling or otherwise altering the item being inspected. Visual inspections are, however, limited by the type, nature and intensity of the illumination that is used. Further, they are significantly dependent on the acuity and resolution that can be obtained using optical instruments. Nevertheless, for many applications, visual inspections are preferred.

For applications where the sequential inspection of a series of items is required, optical, or visual inspection methods may be desirable for several reasons. Specifically, such methods are desirable whenever they can be used to increase the speed of the inspection process without sacrificing the quality of the inspection. Both of these factors, i.e. speed and quality, become particularly important when the human inspector is replaced by optical equipment such as cameras and image processors.

When cameras are used for inspection purposes, there is an inherent trade-off between image resolution and cost. Specifically, cameras that give better image resolution are generally more costly. Further, when image processors are used to recreate and analyze an image that has been taken by a camera, there is an inherent trade-off between processing time and cost. In this case, more costly image processors realize shorter processing times. Optimally, an inspection system would use as many cameras as necessary and as many image processors as necessary. This, however, is not always possible. Therefore, there is a need for an inspection system which has the flexibility that is necessary to properly balance the requirements for cameras and image processors for a particular inspection application.

As mentioned above, in order for there to be a valid inspection of an item, it is necessary that the item be properly illuminated. In some instances, this may require that the item be illuminated from different angles, in order to produce different visual perspectives for the inspection. Also, the movement of the item to and from the inspection station needs to be coordinated and properly controlled. In any event, in order for there to be an effective visual inspection of an individual item, or of a continuous series of items, there are several disparate tasks that need to be coordinated.

In light of the above, it is an object of the present invention to provide an inspection system that has a central control for properly placing an item to be inspected, for properly illuminating the item, for collecting image data from the item, and for the analyzing the image data. It is another object of the present invention to provide an inspection system that has the flexibility to vary the number of cameras, or the number of image processors, to achieve a desirable inspection procedure. Still another object of the present invention is to provide an inspection system that has the flexibility to illuminate an item from different angles using a number of different light sources, to create different visual perspectives of the item. Yet another object of the present invention is to provide an inspection system that is relatively easy to manufacture, is simple to use and is comparatively cost effective.

### SUMMARY OF THE PREFERRED EMBODIMENTS

In accordance with the present invention, an inspection system for identifying defects on the surface of an item includes an information processor that is mounted on a base assembly. Importantly, the information processor functions as a central control facility for the functioning and operation of the inspection system. In this capacity, the information processor coordinates the operation of several separate subassemblies in the system. It is an important aspect of the present invention that the information processor will control each of the subassemblies so that they function, in concert with each other, to evaluate and inspect an item for manufacturing defects.

In addition to the information processor, the subassemblies that comprise the inspection system of the present invention are also mounted on the base assembly. One such subassembly is a tray, or conveyor belt, that is used for holding the item that is to be inspected. Additionally, the tray is electronically connected to the information processor. With this connection, the tray can be selectively moved in response to instructions from the information processor to position the item at a specified inspection station on the base assembly.

Another subassembly of the inspection system that is mounted on the base assembly, and that is also electronically connected to the information processor, is an illuminator. As used for the present invention, the illuminator includes several light sources for illuminating the item while it is at the inspection station. In order to illuminate the item from different perspectives, light from different light sources is directed toward the item along different, selected beam paths. Specifically, the illuminator has one light source that directs light along a beam path that is substantially normal to the surface of the item being inspected. The illuminator also has another light source for directing light along a low angle beam path toward the surface of the item being inspected. For purposes of the present invention, this low angle beam path is inclined from the other beam path at a predetermined angle that is in a range from approximately seventy five degrees to approximately eighty five degrees (75°-85°).

In another embodiment of the present invention, the illuminator may include a plurality of light sources that are arranged as an annulus. The plurality of light sources are separated into groups, with the light sources in each group being arranged as an array of columns and rows. The arrays can then be positioned in a circle so that one row of light sources in each of the arrays will cooperate with other rows of light sources in other arrays to create an annulus of light sources. Thus, there can be a plurality of annulae in a circle, and there can be also be a plurality of circles. In any case, light from the plurality of light sources are directed toward the item along different, selected beam paths in order to illuminate the item from different perspectives.

Once the item being inspected has been moved to the inspection station and illuminated, image data of the item is obtained using a plurality of cameras that are electronically interconnected with a plurality of image processors. As envisioned for the inspection system of the present invention, depending on the degree of resolution and the speed of data acquisition that is desired, there can be an N number of cameras and an M number of image processors. In any case, it is preferable that the N number of cameras are focused onto the surface of the item along paths that are substantially normal to the surface. More specifically, this is accomplished using a lens assembly that focuses the cameras to predetermined portions of the surface of the item. Thus, depending on which light source of the illuminator is being used, the cameras are able to collect image data from the item being inspected from different perspectives.

Importantly, like the tray and the illuminator, the cameras and the image processors are also directly responsive to instructions from the information processor. Accordingly, with instructions from the information processor the inspection system of the present invention is capable of positioning an item, illuminating the item to establish a visual perspective of the item, and then using the cameras and image processors to collect image data from the item. Specifically, the image processors will use the image data to analyze and evaluate the item by comparing it with a template image or in accordance with predefined rules to detect defects in the item.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of the inspection system of the present invention;

FIG. 2 is a perspective view of the gantry assembly of the inspection system;

FIG. 3 is a cross-sectional schematic view of the subassemblies in the gantry assembly as seen along the line 3-3 in FIG. 2;

FIG. 4 is a perspective view of a system of an alternative embodiment of the present invention with portions broken away for clarity;

FIG. 5 is a plan view of a circle of light sources of the alternative embodiment as would be seen along a line 5-5 in FIG. 4;

FIG. 6 is a schematic view of an incident light beam path and a reflected light beam path;

FIG. 7 is a schematic view of light beams from different light sources being reflected from different points on a curved surface along substantially the same reflected beam path;

FIG. 8 is a schematic block diagram of the electronic connections between the various subassemblies and components of the inspection system;

FIG. 9 is a perspective view of an item in FIG. 7 having a contoured surface, with light rays in a beam from a common light source being reflected from points on the surface having the same gradient; as shown, light reflected from these points will travel along substantially the same reflected beam path; and

FIG. 10 is an image of points on the item shown in FIG. 9 which all have the same gradient and which therefore have reflected light along the reflected beam path.

### DESCRIPTION OF THE PREFERRED EMBODIMENT

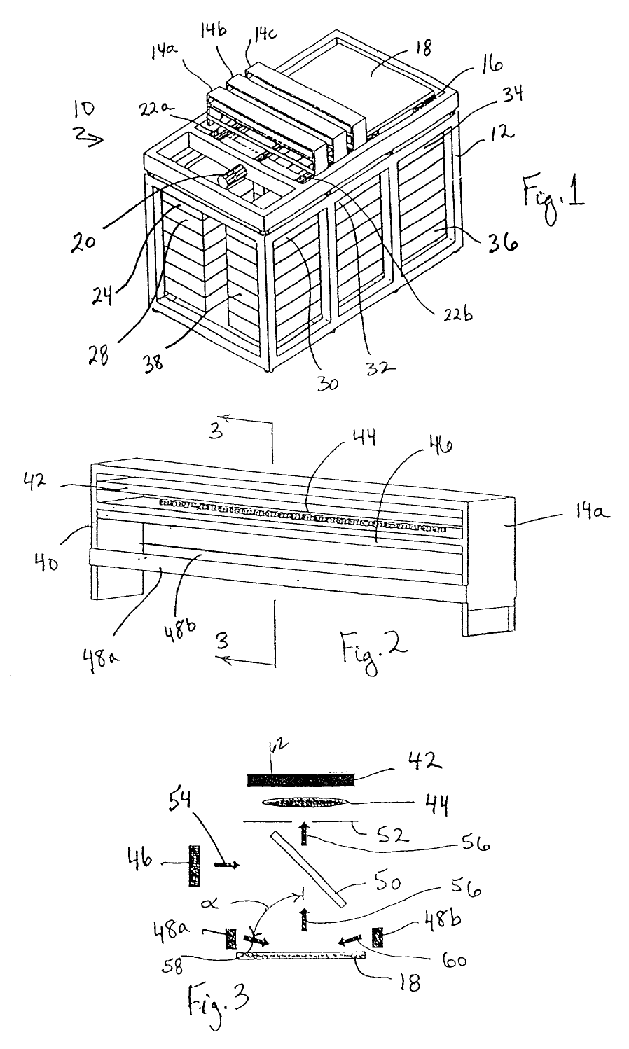

Referring initially to FIG. 1, an inspection system in accordance with the present invention is shown and is generally designated 10. As shown, the inspection system 10 includes a base assembly 12 and at least one gantry assembly 14 that is mounted on the base assembly 12. The gantries 14a-c are only exemplary as it will be appreciated there can be one or several such gantries 14. FIG. 1 also shows that the inspection system 10 includes a tray 16 that is used for holding an item 18 on the base assembly 12. It should be noted that tray 16 may hold a plurality of items 18 depending on a particular need. System 10 also includes a tray positioning motor 20 that is used for moving the tray 16 back and forth along the guide rails 22a and 22b. More specifically, the motor 20 moves the tray 16 between a loading position (as shown in FIG. 1) and an inspection position wherein the tray 16 is located under the gantries 14. The system 10 may also include a vacuum system (not shown) which will assist in holding the item 18 on the tray 16.

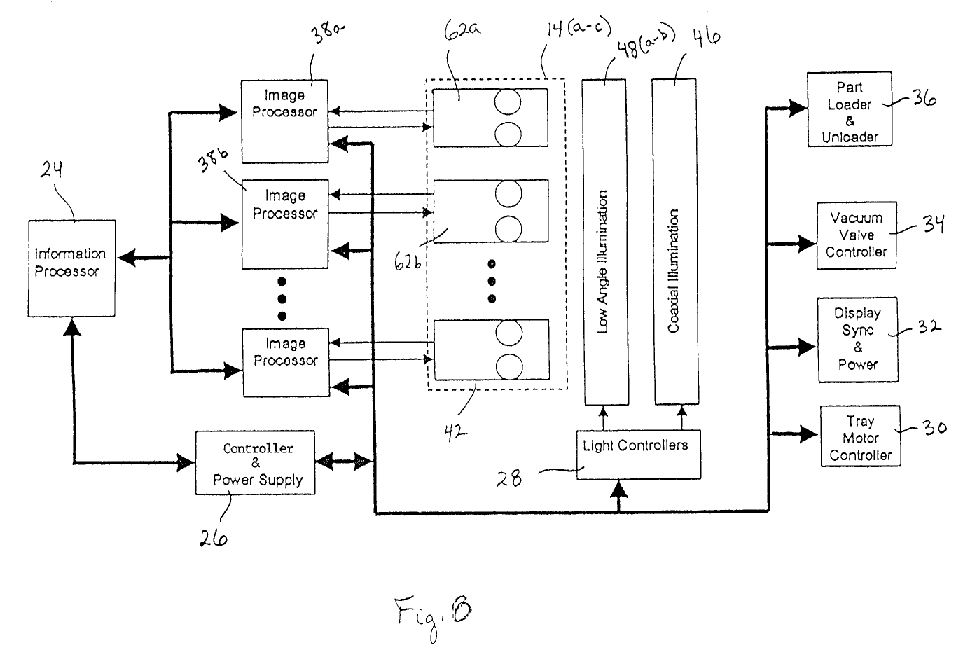

It is an important aspect of the present invention that the inspection system 10 include various control components and support equipment. Specifically, it is intended that these components and equipment be modular, that they be individually and selectively incorporated into the system 10 and that, when so incorporated, they can be interconnected for centralized control. For these purposes, it is to be appreciated that such components can be mounted either on the base assembly 12 or on one of the gantry assemblies 14. For the moment, considering only the base assembly 12, it is seen in FIG. 1 that a variety of individual modular components can be mounted on the base assembly 12. By way of example, components that are to be mounted on the base assembly 12 can include: an information processor 24, a general power supply 26 (See FIG. 8), a tray motor controller 30, a display power supply 32, a vacuum valve controller 34, a part loader 36, and an image processor 38. Actually, the inspection system 10 contemplates there will be a relatively large number (M) of image processors 38 mounted on the base assembly 12. Importantly, the plurality of M image processors 38 will share low data rate information for operation in concert with the image processors 38, and with the controller/power supply 26.

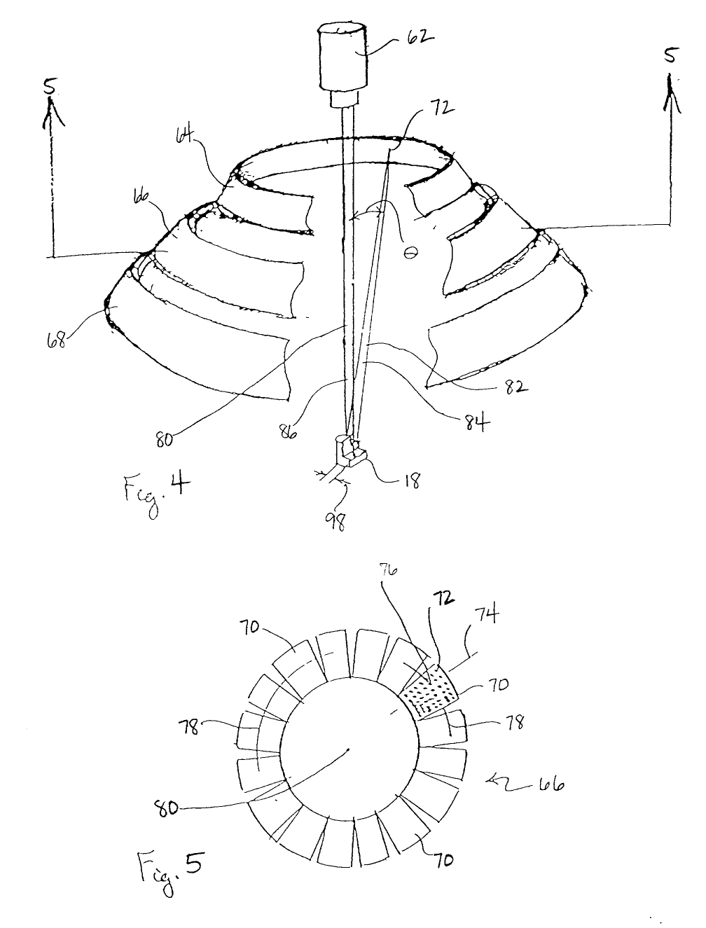

As indicated above, in addition to the components that are mounted on the base assembly 12, other components of the system 10 are mounted on the gantries 14. For example, FIG. 2 shows that the gantry 14a includes a frame 40, and that a camera assembly 42 and a lens assembly 44 are mounted on the frame 40. In particular, the camera assembly 42 and lens assembly 44 are mounted on the gantry 14a such that the camera assembly 42 is positioned directly above the item 18 whenever the tray 16 moves the item 18 into an inspection position. Further, FIG. 2 shows that when the item 18 is located in its inspection position under gantries 14, it is preferable that item 18 be selectively illuminated by three different light sources, from three different perspectives. This is only exemplary as there may be fewer or more light sources depending on the particular need. It also should be noted that the type of light sources used for the present invention can be different from each other, such as using a polarized light source with a monochromatic light source. In any case, these light sources include a coaxial lighting assembly 46 for directing light in a direction toward the item 18 that is substantially perpendicular to the surface of the item 18. Additionally, there are two low angle lighting assemblies 48a and 48b that direct light toward the item 18 at a slant angle, α. As envisioned for the present invention, the angle α will preferably be in a range that is from about seventy five degrees to eighty five degrees (75°-85°). The interaction of the components of inspection system 10 that are mounted on the gantry 14a will be best appreciated with reference to FIG. 3.

In FIG. 3 it can be seen that, in addition to the components mentioned above, a beam splitter 50 and an iris 52 are also mounted on the gantry 14a. Thus, the beam splitter 50, in combination with the coaxial lighting assembly 46 and the low angle lighting assemblies 48a and 48b will function in concert, or individually, as an illuminator for the item 18. Specifically, light from the coaxial lighting assembly 46 is directed as a beam 54 toward the beam splitter 50. At the beam splitter 50, a portion of the light in beam 54 is redirected toward the item 18. This light, in turn, is reflected from the item 18 as a beam 56 that travels toward the camera assembly 42 on a path that is coaxial with the focusing axis of cameras in the camera assembly 42. On the other hand, light from the low angle lighting assembly 48a will travel as a light beam 58 on a path that is inclined at a slant angle, α, to the focusing axis of cameras in the camera assembly 42. Light from the light beam 58, however, will be reflected from the item 18 as part of the light beam 56. In substantially the same manner, light from the low angle lighting assembly 48b will travel toward the item 18 as a light beam 60 on an inclined path. The light beam 60 will then also join light beam 56. In any event, the light in light beam 56 will be used by cameras 62 in the camera assembly 42 to create images of the item 18. As will be appreciated by those skilled in the art, depending on the source of light (i.e. coaxial lighting assembly 46, or low angle lighting assemblies 48a,b), different perspectives of the item 18 can be visualized.

In an alternative embodiment of the present invention, referring to FIG. 4, the system 10 includes at least one light circle 64 and, preferably, will include additional light circles, such as the light circles 66 and 68. For purposes of the present invention, the light circles 64, 66 and 68 will be vertically stacked and lie in respective planes that are substantially parallel to each other. As shown, the light circles 64, 66 and 68 will have progressively increasing diameters, with light circle 64 having the smallest diameter, light circle 66 having an intermediate sized diameter and light circle 68 having the largest diameter.

As best appreciated by reference to FIG. 5, where the light circle 66 is generally shown for exemplary purposes, each of the light circles 64, 66 and 68 will include a plurality of light arrays 70. For the present invention, each light array 70 will include a plurality of light sources 72, and the light sources 72 in each group will be arranged in groups of columns 74 and rows 76. As so arranged, each row 76 of each array 70 will cooperate with a respective row 76 in each of the other arrays 70 to establish an annulus (ring) 78 of light sources. By cross referencing FIG. 5 with FIG. 4, it will be appreciated that the light circles 64, 66 and 68 of the system 10 generally form a hemispherical dome of light sources 72 which is made up of a plurality of substantially parallel annulae (rings) 78. Preferably, each light source 72 is a light-emitting diode (LED) that is capable of generating a beam 82 of semi-collimated light.

In FIG. 4, a particular light source 72 in light circle 64 has been selected for discussion purposes. It is to be appreciated from the above disclosure, however, that the system 10 actually includes a plethora of light sources 72 which are all arranged in a plurality of annulae 78. Further, it is to be appreciated that, with this arrangement, all of the light sources 72 in a selected annulus 78 will lie in a plane. More specifically, the light source 72 in the annulus 78 will be equidistant from an axis 80 that is perpendicular to the plane of the annulus 78. Thus, the light source 72 will generate a cone of light when directed toward a common point on the axis 80.

With the above in mind, and returning to the consideration of a single light source 72, it is seen in FIG. 4 that a light source 72 generates a semi-collimated beam of light 82 which is directed toward an item 18 along an incident beam path 84. The beam 82 is then reflected from the item 18 along a reflected beam path 86 (axis 80) toward a camera 62. As shown in FIG. 4, the angle between the incident beam path 84 and the reflected beam path 86 is designated θ. It is an important aspect of this alternative embodiment that all of the light sources 72 in the system 10 are directed toward the item 18. Thus, although the respective azimuthal angle will be different for each light source 72 in a particular annulus 78, the incident beam paths 84 from all light sources 72 in a particular annulus 78 will be at the same angle θ with respect to the reflected beam path 86. There are, of course, a plurality of annulae 78. Accordingly, light sources 72 in different annulae 78 will have a slightly different angle θ between their respective incident beam paths 84 and the reflected beam path 86. It is another important aspect of the present invention that all of the semi-collimated light beams 82 from all of the light sources 72 in the system 10, regardless of their respective angles θ, will have substantially the same reflected beam path 86 toward a particular camera 62. As indicated above, to accomplish this, each annulus 78 of light sources 72 will lie in a respective plane which is substantially perpendicular to the reflected beam path 86. Further, all of the light sources 72 in the same annulus 78 will be substantially equidistant from the reflected beam path 86. If more than one camera 62 is employed, the position of each camera 62 will define its own particular reflected beam path 86, and will establish a respective angle θ for the incident beam paths 84 from which it will receive light beams 82 from the various light sources 72.

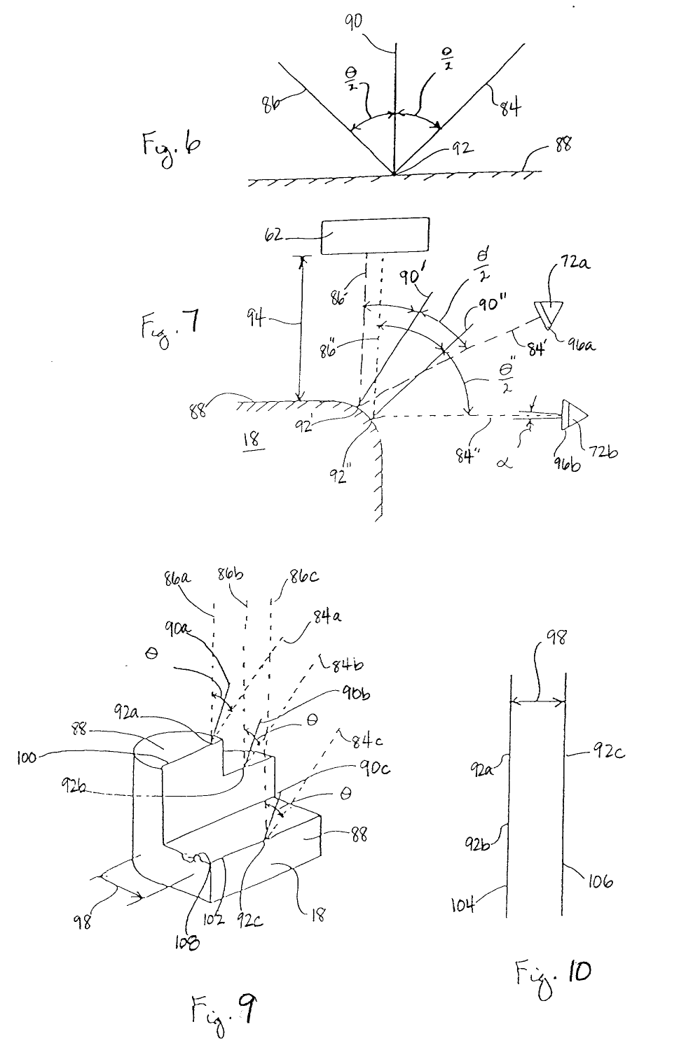

For purposes of disclosure, the phenomenon of the specular or quasispecular reflection of light is schematically depicted in FIG. 6. From FIG. 6 it is to be understood that on any surface 88, a normal 90 can be established at any arbitrary point 92 on the surface 88. By definition, the normal 90 at a point 92 is perpendicular to the surface 88 at the point 92. Further, in accordance with the laws of physics, a light beam 82 that is directed toward the point 92 along an incident beam path 84, will be reflected from the point 92 on surface 88 along a reflected beam path 86 such that the incident beam path 84, the normal 90, and the reflected beam path 86 are coplanar. Also, it must happen that the incident beam path 84 and the reflected beam path 86 make equal angles θ/2 with the normal 90.

In FIG. 6, the surface 88 is shown to be flat. In FIG. 7, however, the surface 88 is shown to be contoured. In each case, regardless whether the surface 88 is flat or contoured, each point 92 on the surface 88 will have its own respective normal 90. As shown in FIG. 7, normals 90 at different points 92 on a contoured surface 88 will have different orientations. For example, the normal 90′ at point 92′ has a different orientation in space than does the normal 90″ at point 92″. On the other hand, for purposes of discussion, if the surface between point 92′ and point 92″ was flat (i.e. in the same plane) the normal 90′ would be parallel to the normal 90″. It happens, as discussed above, that the orientation of a normal 90 at any particular point 92 on a surface 88 can be mathematically expressed as a gradient, ∇θ, where ∇θ=(i∂/∂x+j∂/∂y+k∂/∂z)θ. With this in mind, the physical laws of reflection of light are employed by the system 10 to image gradient profiles on a surface 88 for all points 92 which have the same gradient, ∇θ.

### OPERATION

The overall operation of the inspection system 10 will, perhaps, be best appreciated with reference to FIG. 8. There it will be seen that the information processor 24 is effectively connected to operate in concert with all of the other components of the system 10. Thus, once the information processor 24 instructs the part loader 36 to position a part (e.g. item 18) on the tray 16, the information processor 24 will activate the vacuum valve 34 and instruct the tray motor controller 30 to reposition the tray 16 as required. After the item 18 has been moved to its inspection position under the gantry(ies) 14, the information processor 24 will instruct the light controllers 28 to appropriately activate the coaxial lighting assembly 46 and the low angle lighting assemblies 48a,b. As indicated above, the lighting assemblies 46 and 48a,b can be selectively activated individually, or in various combinations, to establish different visual perspectives for the item 18. Once the item 18 has been properly illuminated, cameras 62 in the camera assembly 42 can be operated with instructions from the information processor 24 to collect image data from the item 18.

For purposes of the present invention, the cameras 62a and 62b shown in FIG. 8 are only exemplary and, it is to be appreciated that there can be a relatively large number, N, of cameras 62. Further, it is to be appreciated that the number of cameras 62 (N) need not be the same as the number of image processors 38 (M). Instead, N and M can be selected according to the functional and operational specifications that are set for the inspection system 10.

When the image data has been collected from the item 18 by camera assembly 42, the image data will be transferred from the camera assembly 42 to predetermined image processors 38. The image processors 38, in turn, compare and evaluate the image data with respect to pre-selected standards, such as an image template. Based on these comparisons the inspection system 10 is able to provide valuable information about the structure, integrity, configuration and constitution of the item 18.

In the operation of the system 10 of the alternative embodiment of the present invention, a camera 62 is positioned at a fixed predetermined distance 94 from an item 18. The light sources 72 in the various annulae 78 of light circles 64, 66, and 68 are then selectively activated to illuminate the item 18. For example, in FIG. 7, a light source 72a (perhaps from light circle 66) and a light source 72b (perhaps from light circle 68) are shown directing semi-collimated light beams along respective incident beam paths 84′ and 84″ toward the surface 88 of item 18. In the context of the present invention, although the individual effect of only one light source 72 may be discussed, it is to be understood that the discussion applies equally to all of the other light sources 72 in the same respective annulus 78. Also, as indicated above, the light beams 82 from each light source 72 are preferably semi-collimated. For some applications, however, it may be desirable for the light from the light source 72 to be perfectly or nearly perfectly collimated. With this in mind, the term “semi-collimated” contemplates nearly parallel light rays which diverge through a relatively small angle. In order to control the diffusion of semi-collimated light, diffusers 96a and 96b, as shown by way of example in FIG. 7, are respectively associated with light sources 72a and 72b. Specifically, the diffuser 96b of light source 72b is shown to spread light from the light source 72 through an angle α. For the present invention, the maximum value for the angle α, is preferably in the range of from ten to sixty degrees (10°- 60°). Recall, however, that collimated light may be useful for some applications. If so, α will be equal to zero.

By being slightly diffused, the semi-collimated light from light source 72a, which travels along the incident beam path 84′, will be incident on both the point 92′ and 92″ of surface 88 (see FIG. 7). Likewise, semi-collimated light from light source 72b, which travels along the incident beam path 84″, will be incident on both the point 92′ and 92″ of surface 88. As intended for the present invention, however, in order for the camera 62 to image either of the points 92′ or 92″, the camera 62 must receive light that is reflected from the particular point 92 along the reflected beam path 86′ or 86″ (note: for purposes of the present invention, the reflected beam paths 86′ and 86″ can be considered to be coincident). As shown in FIG. 7, the point 92′ has a normal 90′ and the point 92″ has a normal 90″. Due to the curvature and contour of the surface 88, however, the normals 90′ and 90″ are not parallel to each other. In accordance with the physical laws discussed above, this means that in order for camera 62 to receive light from point 92′, the normal 90′ at point 92′ will dictate the angle θ′ that is required between the reflected beam path 86′ and the incident beam path 84′. In turn this will determine where the light source 72a should be located. Similarly, in order for camera 62 to receive light from point 92″, the normal 90″ at point 92″ will dictate the angle θ″ that is required. In turn this will determine where the light source 72b should be located. For most applications the reflection angle θ will be somewhere in the range between zero and ninety degrees (0°- 90°).

The consequence of the fact that each point 92 on the surface 88 will have its own normal 90 is that with a predetermined reflected beam path 86 which is established by the location of the camera 62, the orientation of the normal 90 will determine the reflection angle θ for the point 92 and, hence, the required orientation for the incident beam path 84. For example, in FIG. 7, a light beam 82 from light source 72a will be reflected toward the camera 62 along only a reflected beam path 86 from the point 92′. But the angle between the reflected beam path 86 and the normal 90′ at point 92′ is θ′/2. Thus, reflected light from point 92′ will travel along reflected beam path 86 only when the incident beam path 84′ is at an angle θ′/2 from the normal 90′. Stated differently, the camera 62 will image point 92′, but not the point 92″, with light from the light source 72a. Likewise, light from light source 72b will be reflected toward the camera 62 along the reflected beam path 86 from the point 92″ only for a particular orientation of the incident beam path 84″. Again, the orientation of the incident beam path 84″ is dependent on the orientation of the normal 90″ at the point 92″ and the magnitude of the consequent angles θ″/2. In this case, the camera 62 will image the point 92″, but not the point 92′, when only the light source 72b is illuminated. Recall, the light source 72a and the light source 72b will be in different annulae 78 of the system 10 of the alternative embodiment. Consequently, by selectively operating the light sources 72 in the different annulae 78, points 92 on surface 88 can be imaged in isolation. Specifically, all points 92 on the surface 88 which have normals 90 with the same orientation (i.e. the same gradient ∇θ) will be imaged. The result is an image of a gradient profile of the surface 88.

In order to appreciate how an image profile of an item 18 can be obtained in accordance with the present invention, consider FIGS. 9 and 10. For purposes of inspecting the item 18, it may be of utmost importance to determine the magnitude of the distance 98 across the item 18, or to determine the integrity and continuity of ridges, crests, shoulders, edges, corners or other portions of a surface 88 where there is a change in contour. For the moment, however, consider the distance 98.

By way of example, the distance 98 across the item 18 can be determined in accordance with the present invention by measuring the distance between specular reflections from the edge 100 and edge 102 of item 18. This, however, requires that points on edge 100 (e.g. points 92a and 92b) have the same gradient ∇θ as points on the edge 102 (e.g. point 92c). If the gradient ∇θ at the points 92a-c is the same, all of the reflected beam paths 86a-c will be directed from these points 92a-c on the item 18 toward the camera 62. From this it follows that all of the normals 90a-c are substantially parallel to each other, and each of the normals 90a-c is inclined at a same angle θ/2 from their respective reflected beam path 86a-c. Consequently, the points 92a-c and all other points on the edges 100 and 102 having the same gradient ∇θ will be imaged by camera 62. This happens when the incident beam paths 84a-c all come from light sources 72 such that the angle between each of the incident beam paths 84a-c and their respective normals 90a-c is equal to θ/2. Thus, in summary, by knowing the location of camera 62, and by selecting a particular annulus 78, a reflection angle θ between the incident beam paths 84 and the reflected beam path 86 can be established. Then, upon activation of the light sources 72 in the annulus 78, all points 92 on the surface 88 of item 18 which have the same gradient ∇θ will be imaged by the camera 62.

FIG. 10 is a representation of a gradient profile from the item 18 under the conditions which were established above during the discussion of FIG. 9. Importantly, from the lines 104 and 106 in FIG. 10 it is possible to measure the distance 98 with an accuracy that may not be possible with other means. Accordingly, compliance with predetermined standards can be ascertained for inspection purposes. Furthermore, it can be appreciated that a blemish 108 (see FIG. 9) will cause discontinuities in the gradient profile, due to the irregular disruption of normals 90, and can be easily detectable.

It should be noted that in the example given above, all points 92 having the same gradient ∇θ showed up as lines 104 and 106. This was because the points 92 were all located on edges where the gradient ∇θ was changing. Recall, a flat surface will have the same gradient ∇θ at all points on the surface. A specular reflection from a flat surface would then be imaged as an area rather than a line.

While the particular Linked Cameras and Processors for Imaging System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. An inspection system for identifying defects on a surface of an item which comprises:
a base assembly;
an information processor mounted on said base assembly;
a tray mounted on said base assembly for holding said item, said tray being connected to said information processor for selective movement of said tray to position said item at an inspection station in response to instructions from said information processor;
an illuminator connected to said information processor for selectively illuminating said item at said inspection station in response to instructions from said information processor;
a plurality of cameras connected to said information processor for collecting image data from said illuminated item in response to instructions from said information processor; and
a plurality of image processors mounted on said base assembly and interconnected with said plurality of cameras for analyzing said image data in comparison with a template image to detect defects in said item.

2. An inspection system as recited in claim 1 wherein said plurality of cameras includes an N number of cameras and said plurality of image processors includes an M number of image processors.

3. An inspection system as recited in claim 1 wherein said illuminator comprises:
a first light source for directing light along a first beam path toward said surface of said item, said first beam path being substantially normal to said surface of said item; and
a second light source for directing light along a second beam path toward said surface of said item, said second beam path being inclined at a predetermined angle to said first beam path.

4. An inspection system as recited in claim 3 wherein said predetermined angle is in a range from approximately seventy five degrees to approximately eighty five degrees.

5. An inspection system as recited in claim 3 wherein said plurality of cameras are focused on said surface of said item substantially along said first beam path.

6. An inspection system as recited in claim 3 wherein said illuminator further comprises a third light source for directing light along a third beam path toward said surface of said item, said third beam path being substantially coplanar with said first and second beam paths, said third beam path being inclined from said second beam path at substantially two times said predetermined angle with said first beam path therebetween.

7. An inspection system as recited in claim 3 further comprising a lens assembly for focusing said plurality of cameras to predetermined portions of said surface of said item.

8. An inspection system as recited in claim 1 wherein said illuminator comprises a plurality of light sources for directing light beams along respective beam paths toward said item for said plurality of light sources to create a cone of light beams.

9. An inspection system as recited in claim 8 wherein said plurality of light sources are arranged as an annulus.

10. An inspection system as recited in claim 8 wherein said plurality of light sources are separated into a plurality of groups and each said group is mounted as an array of columns and rows of said light sources, with a plurality of said arrays positioned in a circle of arrays for one said row of light sources in each of said arrays cooperate with other said rows of light sources in other said arrays to create an annulus of said light sources.

11. An inspection system as recited in claim 1 further comprising a gantry mounted on said base assembly, with said illuminator and said plurality of cameras mounted on said gantry.

12. An inspection system as recited in claim 1 wherein said tray moves in reciprocation on said base assembly between said inspection station and a loading station, said loading station being provided to remove and replace said items.

13. An inspection system for identifying defects on a surface of an item which comprises:
an information processor;
means connected with said information processor for selective movement of said item, to position said item at an inspection station in response to instructions from said information processor;
means connected with said information processor for selectively illuminating said item at said inspection station along a plurality of selected beam paths in response to instructions from said information processor;
means connected with said information processor for collecting image data from said illuminated item in response to instructions from said information processor;
means mounted on said base assembly and interconnected with said image collecting means for analyzing said image data in comparison with a template image to detect defects in said item; and
a lens assembly for focusing said plurality of cameras to predetermined portions of said surface of said item.

14. An inspection system as recited in claim 13 wherein said illuminating means is an illuminator which comprises:
a first light source for directing light along a first beam path toward said surface of said item, said first beam path being substantially normal to said surface of said item;
a second light source for directing light along a second beam path toward said surface of said item, said second beam path being inclined at a predetermined angle to said first beam path; and
a third light source for directing light along a third beam path toward said surface of said item, said third beam path being substantially coplanar with said first and second beam paths, said third beam path being inclined from said second beam path at substantially two times said predetermined angle with said first beam path therebetween.

15. An inspection system as recited in claim 14 wherein said means for collecting image data is a plurality of cameras wherein said plurality of cameras are focused on said surface of said item substantially along said first beam path and further wherein said analyzing means is a plurality of image processors, and wherein said system includes an N number of cameras and an M number of image processors and wherein said predetermined angle is in a range from approximately seventy five degrees to approximately eighty five degrees.

16. A method for manufacturing an inspection imaging system which comprises the steps of:
providing a base assembly having an information processor mounted on said base assembly;
mounting a tray on said base assembly for holding an item to be inspected, said tray being connected to said information processor for selective movement of said tray to position said item at an inspection station in response to instructions from said information processor;
connecting an illuminator to said information processor for illuminating said item at said inspection station along a plurality of selected beam paths in response to instructions from said information processor;
attaching a plurality of cameras to said information processor for collecting image data from said illuminated item in response to instructions from said information processor; and
interconnecting a plurality of image processors with said plurality of cameras for analyzing said image data in comparison with a template image to detect defects in said item.

17. A method as recited in claim 16 wherein said illuminator comprises:
a first light source for directing light along a first beam path toward said surface of said item, said first beam path being substantially normal to said surface of said item; and
a second light source for directing light along a second beam path toward said surface of said item, said second beam path being inclined at a predetermined angle to said first beam path.

18. A method as recited in claim 17 wherein there are an N number of cameras and an M number of image processors and wherein said predetermined angle is in a range from approximately seventy five degrees to approximately eighty five degrees.

19. A method as recited in claim 18 wherein said plurality of cameras are focused on said surface of said item substantially along said first beam path by a lens assembly with said lens assembly focusing said plurality of cameras to predetermined portions of said surface of said item.

20. A method as recited in claim 16 further comprising the step of affixing a gantry on said base assembly, with said illuminator and said plurality of cameras mounted on said gantry.
